(19) United States
(12) Patent Application Publication
(10) Pub. No.: US 2026/0364799 A1
(43) Pub. Date: Nov. 19, 2026

(54) STUCK RECOVERY METHOD AND SYSTEM FOR SELF-MOVING CLEANING ROBOT, AND FLOOR-CLEANING ROBOT

(71) Applicant: Dreame Innovation Technology (Suzhou) Co., Ltd., Suzhou (CN)

(72) Inventors: Yunxia SHENG, Suzhou (CN); Weinan QIU, Suzhou (CN); Zebin CAO, Suzhou (CN); Zhenguan TU, Suzhou (CN)

(21) Appl. No.: 19/697,464

(22) Filed: Jun. 3, 2026

Related U.S. Application Data
(63) Continuation of application No. PCT/CN2025/142297, filed on Dec. 12, 2025.

(30) Foreign Application Priority Data
May 13, 2025 (CN) 202510615160.5

(51) Int. Cl. B25J 9/16; B25J 11/00; B25J 13/08

(52) U.S. Cl. CPC B25J 9/1679; B25J 9/1612; B25J 9/162; B25J 11/0085; B25J 13/089

(57) ABSTRACT

Provided are a stuck recovery method and system for a self-moving cleaning robot, and a floor-cleaning robot. The stuck recovery method includes: detecting whether the self-moving cleaning robot is in a stuck state; in response to the stuck state, scanning a local stuck environment; identifying removable obstacles in the local stuck environment and a target obstacle among the removable obstacles; and removing the target obstacle by a removal component of the self-moving cleaning. The present disclosure can establish a closed loop logic of “stuck-state determination - object identification - grasp decision making - stuck recovery execution”, and deeply couple the built-in removal component with an object identification function. This enables a floor-cleaning robot to actively identify and grasp a surrounding movable obstacle when struck, thereby achieving autonomous stuck recovery by changing an environmental layout.

### CROSS-REFERENCE TO RELATED APPLICATIONS

This application is a continuation of International Application No. PCT/CN2025/142297, filed on Dec. 12, 2025, which claims priority to Chinese Patent Application No. 202510615160.5, filed with the China National Intellectual Property Administration on May 13, 2025, and entitled “STUCK RECOVERY METHOD AND SYSTEM FOR SELF-MOVING CLEANING ROBOT, AND FLOOR-CLEANING ROBOT”. The disclosures of the aforementioned applications are hereby incorporated by reference in their entireties.

### TECHNICAL FIELD

The present application relates to the technical field of smart home, and specifically relates to a stuck recovery method and system for a self-moving cleaning robot, and a floor-cleaning robot.

### BACKGROUND

When conventional floor-cleaning robots get stuck upon encountering obstacles (e.g., toys, shoes, clothing, etc.), passive avoidance is typically performed merely through collision detection, infrared obstacle avoidance or a path planning algorithm. If the obstacles are densely distributed or the space is narrow, the floor-cleaning robots are very likely to enter a state of repeated collisions and fail to achieve stuck recovery.

Although existing floor-cleaning robots with a robotic arm can organize items, such functions are limited to preset tasks (e.g., putting scattered items back in predefined positions) and are not linked to a stuck recovery logic, and the grasping capability of the robotic arm is not used to solve the struck problem. Therefore, current stuck recovery solutions mostly rely on remote manual intervention or involve sacrificing cleaning coverage (e.g., by marking an obstacle area and then bypassing same), and thus have insufficient levels of intelligence. In the prior art, there is a lack of solutions related to active stuck recovery of mobile robots.

### SUMMARY

It is an objective of the embodiments of the present application to provide a stuck recovery method and system for a self-moving cleaning robot, and a floor-cleaning robot, enabling the floor-cleaning robot to actively identify and grasp a surrounding movable obstacle when struck, thereby achieving autonomous stuck recovery by changing an environmental layout.

In order to achieve the above objective, in a first aspect of the present application, a stuck recovery method for a self-moving cleaning robot is provided. The stuck recovery method includes: detecting whether the self-moving cleaning robot is in a stuck state;

in response to the self-moving cleaning robot being in the stuck state, scanning a local stuck environment of the self-moving cleaning robot; identifying removable obstacles in the local stuck environment and a target obstacle among the removable obstacles; and removing the target obstacle by a removal component of the self-moving cleaning robot.

In an embodiment of the present application, the removal component is a robotic arm configured to grasp the target obstacle to remove the target obstacle, where removing the target obstacle by a removal component of the self-moving cleaning robot includes: determining whether a predefined safety region exists in the local stuck environment; and in response to the existence of the predefined safety region, grasping the target obstacle by the robotic arm and moving the target obstacle to the predefined safety region.

In an embodiment of the present application, removing the target obstacle by a removal component of the self-moving cleaning further includes: in response to the non-existence of the predefined safety region, grasping the target obstacle by the robotic arm and maintaining a grasping state.

In an embodiment of the present application, identifying removable obstacles in the local stuck environment and a target obstacle among the removable obstacles includes: determining, by means of a visual recognition model, the removable obstacles in the local stuck environment and a relative pose of each removable obstacle with respect to the removal component; and determining, by means of an obstacle contribution evaluation algorithm, the target obstacle among the removable obstacles, where removing the target obstacle by a removal component of the self-moving cleaning includes: determining a removal path of the removal component based on the relative pose of each removable obstacle with respect to the removal component.

In an embodiment of the present application, the obstacle contribution evaluation algorithm includes: calculating a spatial release volume of each removable obstacle; and the number of target obstacles is set to one, and determining, by means of an obstacle contribution evaluation algorithm, the target obstacle among the removable obstacles further includes: determining, by means of the obstacle contribution evaluation algorithm, a ranking of a plurality of removable obstacles in descending order of spatial release volumes; and determining a removable obstacle with the greatest spatial release volume as the target obstacle.

In an embodiment of the present application, the obstacle contribution evaluation algorithm includes: determining a removal contribution of each removable obstacle in a weighted manner based on a weight, a distance, a removal method, and an occupied space of each removable obstacle, where the number of target obstacles is set to one or more, and determining, by means of an obstacle contribution evaluation algorithm, the target obstacle among the removable obstacles includes: determining, by means of the obstacle contribution evaluation algorithm, respective removal contributions of the removable obstacles and a maximum removal contribution among the removal contributions; and in response to the maximum removal contribution being greater than or equal to a predefined threshold, determining each of one or more removable obstacles whose removal contributions are greater than the predefined threshold as the target obstacle.

In an embodiment of the present application, there are a plurality of removable obstacles, and determining, by means of an obstacle contribution evaluation algorithm, the target obstacle among the removable obstacles further includes: in response to the maximum removal contribution being less than the predefined threshold, determining a ranking of the plurality of removable obstacles in descending order of contributions; determining, based on the contribution-based ranking, the first N removable obstacles whose sum of removal contributions is greater than the predefined threshold, where N ≥ 2; and determining the first N removable obstacles as the target obstacle.

In an embodiment of the present application, after removing the target obstacle by a removal component of the self-moving cleaning, the stuck recovery method further includes: updating an environmental map; and determining, based on the updated environmental map, whether the self-moving cleaning robot is in the stuck state, where in response to determining that the self-moving cleaning robot is not in the stuck state, the self-moving cleaning robot is controlled to perform a predefined task logic; or in response to determining that the self-moving cleaning robot is in the stuck state, the stuck recovery method for a self-moving cleaning robot is iteratively executed, a secondary stuck recovery method is executed, or an alarm is triggered.

In an embodiment of the present application, the secondary stuck recovery method includes: controlling the self-moving cleaning robot to adjust stuck recovery poses; and controlling, at each stuck recovery pose, the self-moving cleaning robot to perform the stuck recovery method for a self-moving cleaning robot.

In an embodiment of the present application, the stuck recovery method further includes determining whether the self-moving cleaning robot is in the stuck state by: planning a task path in the environmental map of the self-moving cleaning robot based on the predefined task logic of the self-moving cleaning robot; in response to successful planning of a task path satisfying the predefined task logic, determining that the self-moving cleaning robot is not in the stuck state; and in response to failure to plan a task path satisfying the predefined task logic, determining that the self-moving cleaning robot is in the stuck state.

In another aspect of the present application, a stuck recovery system for a self-moving cleaning robot is provided. The stuck recovery system includes: a detection device configured to detect whether the self-moving cleaning robot is in a stuck state; a scanning device configured to, in response to the self-moving cleaning robot being in the stuck state, scan a local stuck environment of the self-moving cleaning robot; an identification device configured to identify removable obstacles in the local stuck environment and a target obstacle among the removable obstacles; and a removal component disposed on the self-moving cleaning robot and configured to remove the target obstacle.

In a further aspect of the present application, a floor-cleaning robot is provided. The floor-cleaning robot includes the stuck recovery system for a self-moving cleaning robot as described above.

By means of the above technical solutions, the present disclosure can establish a closed loop logic of “stuck-state determination - object identification - grasp decision making - stuck recovery execution”, and deeply couple the built-in removal component with an object identification function. This enables a floor-cleaning robot to actively identify and grasp a surrounding movable obstacle when struck, thereby achieving autonomous stuck recovery by changing an environmental layout. Moreover, the present disclosure can also reduce the frequency of manual intervention and improve the cleaning efficiency in complex scenarios.

Other features and advantages of the embodiments of the present application will be described in detail in the following detailed description section.

### BRIEF DESCRIPTION OF DRAWINGS

The drawings are used to provide a further understanding of the embodiments of the present application and form part of the specification, and together with the following detailed description section, serve to explain the embodiments of the present application, but do not limit the embodiments of the present application. In the drawings:

FIG. 1 schematically shows a schematic flowchart of a stuck recovery method for a self-moving cleaning robot according to an embodiment of the present application;

FIG. 2 schematically shows a schematic diagram of a stuck recovery scenario of a floor-cleaning robot according to an embodiment of the present application;

FIG. 3 schematically shows a schematic diagram of a stuck recovery logic of the floor-cleaning robot according to an embodiment of the present application; and

FIG. 4 schematically shows a schematic structural diagram of a stuck recovery system for a self-moving cleaning robot according to an embodiment of the present application.

### DESCRIPTION OF EMBODIMENTS

In order to make the objectives, technical solutions and advantages of the embodiments of the present application more apparent, the technical solutions in the embodiments of the present application will be described below clearly and completely in conjunction with the accompanying drawings of the embodiments of the present application. It should be understood that specific implementations described here are for the purpose of illustrating and explaining the embodiments of the present application only and are not intended to limit the embodiments of the present application. All other embodiments obtained by those of ordinary skill in the art based on the embodiments of the present application without creative efforts shall fall within the scope of protection of the present application.

It should be noted that if a directional indication (such as up, down, left, right, front, rear, etc.) is involved in the embodiments of the present application, the directional indication is merely used to explain a relative positional relationship between components under a certain attitude (as shown in the drawings), movement conditions thereof, etc. If the specific attitude changes, the directional indication changes accordingly.

In addition, if the terms “first”, “second”, etc. are described in the embodiments of the present application, the terms “first”, “second”, etc. are for descriptive purposes only, and cannot be understood as indicating or implying the relative importance or implicitly indicating the number of indicated technical features. Therefore, a feature defined with “first” or “second” may explicitly or implicitly include at least one such feature. In addition, the technical solutions in various embodiments may be combined with each other, provided that such combinations can be implemented by those of ordinary skill in the art. When a combination of technical solutions is contradictory or cannot be implemented, such a combination of technical solutions shall be deemed not to exist and shall not fall within the scope of protection of the present application.

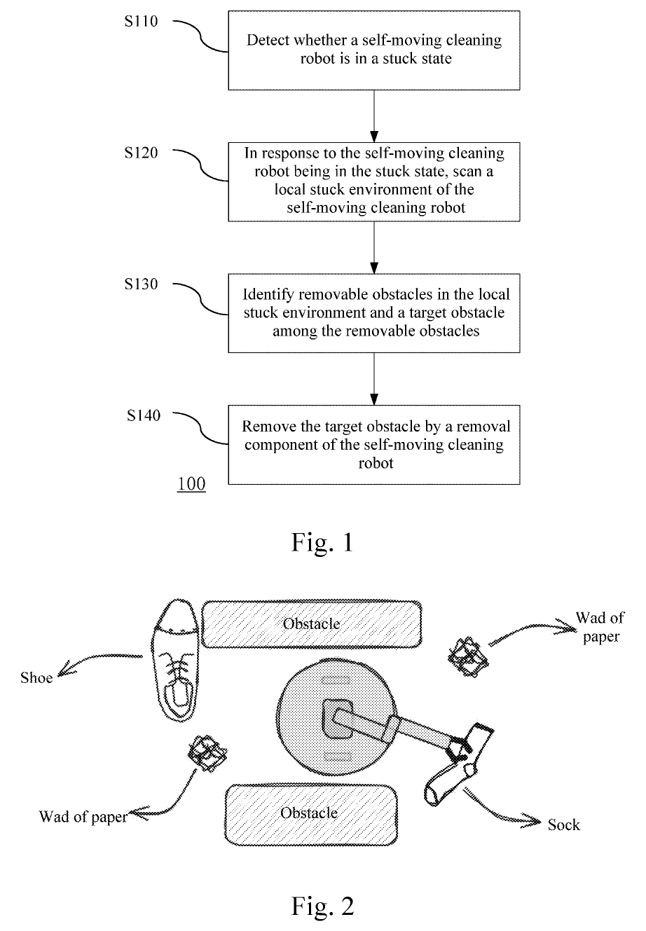

First, a stuck recovery method for a self-moving cleaning robot is provided in the embodiments of the present application. The self-moving cleaning robot is, for example, a floor-cleaning robot. As shown in the schematic flowchart of FIG. 1, the stuck recovery method 100 may include steps S110-S140.

In step S110, it is detected whether the self-moving cleaning robot is in a stuck state.

Specifically, step S110 may include determining whether the self-moving cleaning robot is in the stuck state by the following steps S111-S113.

In step S111, a task path is planned in an environmental map of the self-moving cleaning robot based on a predefined task logic of the self-moving cleaning robot.

In step S112, in response to successful planning of a task path satisfying the predefined task logic, it is determined that the self-moving cleaning robot is not in the stuck state.

In step S113, in response to failure to plan a task path satisfying the predefined task logic, it is determined that the self-moving cleaning robot is in the stuck state.

In an embodiment of the present application, the self-moving cleaning robot may perform the above steps S111-S113 by means of a built-in detection unit or a stuck-state determination unit, thereby determining whether the self-moving cleaning robot enters the “stuck state” based on the environmental map and a cleaning logic (i.e., the predefined task logic).

In step S120, in response to the self-moving cleaning robot being in the stuck state, a local stuck environment of the self-moving cleaning robot is scanned.

Subsequently, in response to determining that the self-moving cleaning robot is in the stuck state, a local stuck environment of the self-moving cleaning robot is scanned. In an embodiment of the present application, the self-moving cleaning robot may be equipped with a depth camera to acquire three-dimensional information of an environment in real time, thereby obtaining a local environment composed of a plurality of obstacles.

In step S130, removable obstacles in the local stuck environment and a target obstacle among the removable obstacles are identified.

In an embodiment of the present application, the self-moving cleaning robot may also identify removable obstacles (e.g., shoes, toys, wads of paper, and other predefined categories) in the acquired three-dimensional environment in real time by means of the depth camera, and identify a target obstacle from the removable obstacles using a preset algorithm based on obstacle attributes (size and material).

In an embodiment of the present application, step S130 may include the following steps S131-S132.

In step S131, the removable obstacles in the local stuck environment and a relative pose of each removable obstacle with respect to a removal component are determined by means of a visual recognition model.

Screenshots of graspable objects (i.e., removable obstacles, such as shoes, toys, wads of paper, and other predefined categories) may be pre-input into an AI visual recognition model for training and learning, to obtain a visual recognition model whose recognition accuracy meets requirements so as to identify the removable obstacles. Subsequently, in this method, relative grasp poses of the self-moving cleaning robot corresponding to different types of removable obstacles may also be calculated to facilitate subsequent grasp and removal.

In step S132, the target obstacle among the removable obstacles is determined by means of an obstacle contribution evaluation algorithm.

The obstacle contribution evaluation algorithm may be run on a built-in stuck-recovery decision-making module of the self-moving cleaning robot to perform grasp feasibility analysis on the removable obstacles. In some embodiments, a fixed-value scoring method or a preferential grasp method may be used to determine the target obstacle among the removable obstacles. For example, in the case of a plurality of removable obstacles and one target obstacle, the preferential grasp method may be used. The obstacle contribution evaluation algorithm may include calculating a spatial release volume of each removable obstacle, and step S132 may include:
1) determining, by means of the obstacle contribution evaluation algorithm, a ranking of a plurality of removable obstacles arranged in descending order of spatial release volumes; and
2) determining a removable obstacle with the greatest spatial release volume or the first M removable obstacles in the spatial-release-volume-based ranking as the target obstacle.

Here, M ≥ 1. That is, when it is determined that a plurality of categories of graspable items exist, if M is set to 1, an object that can most significantly increase the traversable space after being moved is preferentially selected as the target obstacle; or if M is set to be greater than 1, for example, to 3, the first three objects that can significantly increase the traversable space after being moved are preferentially selected as the target obstacle.

In addition, in the case of one or more target obstacles, the fixed-value scoring method may be used, and step S132 may alternatively include the following steps.

In step 1), respective removal contributions of the removable obstacles and a maximum removal contribution among the removal contributions are determined by means of the obstacle contribution evaluation algorithm.

Specifically, the obstacle contribution evaluation algorithm may include: determining a removal contribution of each removable obstacle in a weighted manner based on a weight, a distance, a removal method, and an occupied space of each removable obstacle. It should be noted that: the obstacle contribution evaluation algorithm (e.g., spatial release volumes, etc.) may be implemented using any existing technology, and weights of the individual metrics may be set according to the actual application, without limitations here.

In step 2), in response to the maximum removal contribution being greater than or equal to a predefined threshold, each of one or more removable obstacles whose removal contributions are greater than the predefined threshold is determined as the target obstacle.

That is, if removal contributions of one or more removable obstacles are greater than or equal to the predefined threshold, it indicates that the removal of any of these removable obstacles can produce a spatial release volume meeting the requirements, thereby producing a positive effect on the traversal of the self-moving cleaning robot. Therefore, these removable obstacles may each be determined as the target obstacle, and subsequently the removable obstacles may be grasped and removed either arbitrarily or sequentially.

In step 3), in response to the maximum removal contribution being less than the predefined threshold, a ranking of the plurality of removable obstacles in descending order of contributions is determined; the first N removable obstacles whose sum of removal contributions is greater than the predefined threshold are determined based on the contribution-based ranking, where N ≥ 2; and the first N removable obstacles is determined as the target obstacle.

That is, if there is no removable obstacle whose removal contribution is greater than the predefined threshold, it indicates that the removal of any individual removable obstacle cannot produce a spatial release volume meeting the requirements, so the removal of a single removable obstacle is insufficient for stuck recovery of the self-moving cleaning robot. In this respect, the plurality of removable obstacles may be determined as the target obstacle by the above-mentioned steps. If the sum of removal contributions of some removable obstacles is greater than the predefined threshold, it indicates that the removal of these removable obstacles can produce a spatial release volume meeting the requirements, thereby achieving stuck recovery of the self-moving cleaning robot. That is, it may be determined, based on the contribution-based ranking, to remove the first N removable obstacles whose sum of removal contributions is greater than the predefined threshold, and the first N removable obstacles may be determined as the target obstacle to be all grasped and removed subsequently.

In step S140, the target obstacle is removed by a removal component of the self-moving cleaning.

The removal component may be a robotic arm configured to grasp the target obstacle so as to remove the target obstacle. Therefore, by virtue of the active grasping capability of the robotic arm, the movable obstacle may be used as an intervention target for stuck recovery, thereby dynamically expanding the robot’s degree of freedom of movement. The self-moving cleaning robot may control the operation of the robotic arm by means of a robotic arm control module, i.e., controlling the robotic arm to invoke a pre-trained grasping strategy based on an object type, thereby removing the target obstacle. For example, it is possible that an object is moved to a temporary safety region and the robotic arm is retracted, or that a current grasping state may be temporarily maintained when there is no safety region around. Specifically, step S140 may include the following steps.

In step S141, a removal path of the removal component is determined based on the relative pose of each removable obstacle with respect to the removal component. That is, graspable objects (e.g., shoes, toys, wads of paper, and other predefined categories) may be identified as the target obstacle based on the trained AI visual recognition model described above, and relative poses of the graspable objects with respect to the robotic arm may be calculated. Then, a removal path of the removal component (e.g., the robotic arm) is determined based on the relative pose of each removable obstacle with respect to the removal component to facilitate a grasping operation.

In addition, the robotic arm may be further configured to maintain the grasping state or move the target obstacle to a predefined safety region after the target obstacle is grasped. If the robotic arm is currently in a retracted state, the cleaning logic may continue to be executed directly. Specifically, step S140 may include steps S142-S144.

In step S142, it is determined whether a predefined safety region exists in the local stuck environment.

In step S143, in response to the existence of the predefined safety region, the target obstacle is grasped by the robotic arm and the target obstacle is moved to the predefined safety region.

In step S144, in response to the non-existence of the predefined safety region, the target obstacle is grasped by the robotic arm and a grasping state is maintained.

That is, first, it is necessary to determine whether a predefined safety region exists in the local stuck environment, and if the predefined safety region does not exist and the robotic arm is currently in the grasping state, the robot may grasp the object as needed, and move while maintaining the object grasping state, i.e., carrying the target obstacle for stuck recovery. Alternatively, if the predefined safety region exists, the robot may first grasp the item and move to a predetermined region, then place the item into the region, and return to the cleaning logic after the robotic arm enters the retracted state.

In summary, the present disclosure aims to propose a stuck recovery method for a self-moving cleaning robot, such that a closed loop logic of “stuck-state determination - object identification - grasp decision making - stuck recovery execution” can be established, and a built-in removal component can be deeply coupled with an object identification function. This enables a floor-cleaning robot to actively identify and grasp a surrounding movable obstacle when struck, thereby achieving autonomous stuck recovery by changing an environmental layout. Moreover, the present disclosure can also reduce the frequency of manual intervention and improve the cleaning efficiency in complex scenarios.

In addition, in an embodiment, after step S140, the stuck recovery method 100 of the present disclosure may further include steps S151-S154.

In step S151, an environmental map is updated.

The above-mentioned function may be implemented by means of a dynamic path replanning module. That is, after an obstacle is removed, the environmental map should be updated and an attempt should be made to generate a new stuck-recovery navigation path based on the updated environmental map.

In step S152, it is determined, based on the updated environmental map, whether the self-moving cleaning robot is in the stuck state.

In addition, whether the self-moving cleaning robot is in the stuck state may be determined by:
1) planning a task path in the environmental map of the self-moving cleaning robot based on the predefined task logic of the self-moving cleaning robot;
2) in response to successful planning of a task path satisfying the predefined task logic, determining that the self-moving cleaning robot is not in the stuck state; and
3) in response to failure to plan a task path satisfying the predefined task logic, determining that the self-moving cleaning robot is in the stuck state.

In step S153, in response to determining that the self-moving cleaning robot is not in the stuck state, the self-moving cleaning robot is controlled to perform the predefined task logic.

Specifically, after the robot determines that it is no longer in the struck environment, it may choose, depending on the current grasping state of the robotic arm, to move while maintaining the object grasping state, or to move the item to a predetermined region first and then continue to perform the predefined task logic (e.g., a cleaning logic of a floor-cleaning robot).

In step S154, in response to determining that the self-moving cleaning robot is in the stuck state, the stuck recovery method for a self-moving cleaning robot is iteratively executed, a secondary stuck recovery method is executed, or an alarm is triggered.

In other words, if execution of the above-mentioned stuck recovery method once fails to achieve stuck recovery, the method may continue to be iteratively executed multiple times. This is because after a plurality of target obstacles are identified, traversal may be enabled by removing only one or several of the target obstacles. Therefore, for efficiency considerations, the present disclosure is not limited to removing all of the identified target obstacles. As shown in FIG. 2, upon identifying that the removable obstacle includes a shoe, a sock and wads of paper, the shoe and the sock are determined as the target obstacle, and only removing the sock may enable traversal in this case. However, in more complex cases, in which only removing the sock is insufficient to enable traversal, the shoe and the wads of paper may be sequentially removed until a traversable state is restored.

The secondary stuck recovery method is applicable in a scenario where the self-moving cleaning robot fails to remove the identified target obstacle due to an attitude-related reason (e.g., the robotic arm and the target obstacle fail to be directly connected to each other). Thus, the secondary stuck recovery method may include: controlling the self-moving cleaning robot to adjust stuck recovery poses; and controlling, at each stuck recovery pose, the self-moving cleaning robot to perform the stuck recovery method for a self-moving cleaning robot. In other words, the pose of the self-moving cleaning robot may be adjusted (including fine adjustments of rotation angle and position) based on the actual situation, and then the above-mentioned stuck recovery method may be repeatedly executed until the traversable state is restored.

If stuck recovery cannot be achieved by the iterative execution of the above-mentioned stuck recovery method for a self-moving cleaning robot multiple times and the execution of the secondary stuck recovery method, it indicates that the self-moving cleaning robot cannot implement stuck recovery in accordance with the predefined stuck recovery logic. In this case, an alarm needs to be triggered for resolution through manual intervention.

In summary, in order to perform the above-mentioned functions, the self-moving cleaning robot of the present disclosure may further include the following modules.

### (1) Multimodal perception module

A depth camera and a robotic arm end force sensor are provided to acquire environment three-dimensional information and obstacle attributes (size and material) in real time. Graspable objects (e.g., shoes, toys, wads of paper, and other predefined categories) are identified based on the visual AI model, and relative poses of the graspable objects with respect to the robotic arm are calculated.

### (2) Stuck-recovery decision-making module

A stuck-state determination unit determines, based on the cleaning logic, whether the “stuck state” is entered. A grasp feasibility analysis module determines whether a category of graspable item exists, and if so, an object that is lightweight and easy to grip and that can significantly increase the traversal space after being moved is preferentially selected.

### (3) Robotic arm control module

A pre-trained grasping strategy is invoked based an object type, and an obstacle-avoidance motion trajectory is planned. The object is moved to a temporary safety region and the robotic arm is retracted; or a current grasping state is temporarily maintained (when there is no safety region around).

### (4) Dynamic path replanning module

After an obstacle is removed, an environmental map is updated and a new stuck-recovery navigation path is generated. After the robot determines that it is no longer in the stuck environment, it chooses to move the item to a predetermined region first or to continue the cleaning logic, depending on a current state. If the robotic arm is currently in the grasping state, the item needs to be moved to the predetermined region before returning to the cleaning logic. If the robotic arm is currently in the retracted state, the cleaning logic may continue to be executed directly.

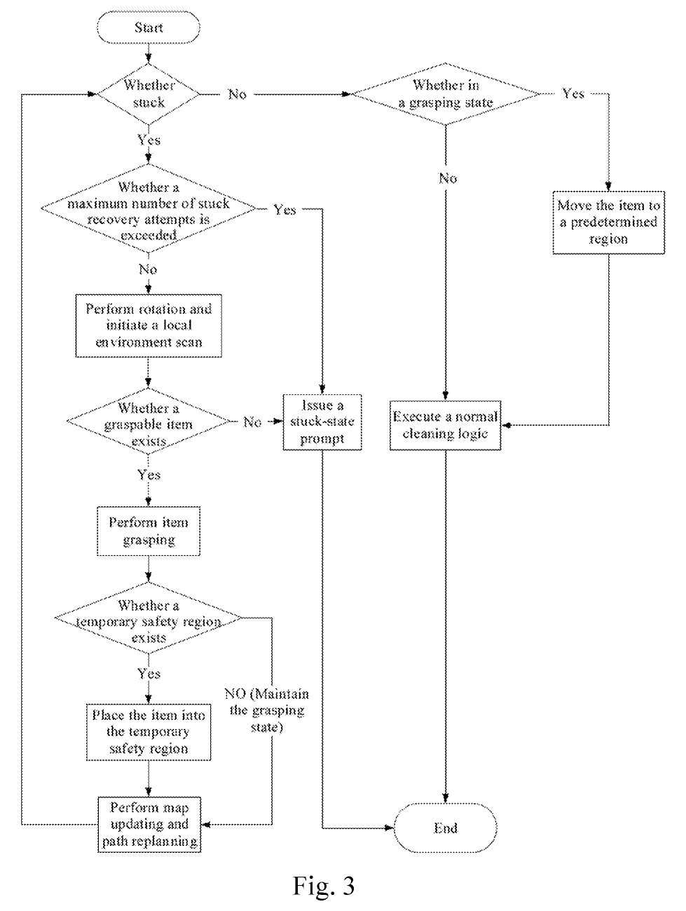

In addition, a workflow of the stuck recovery logic of the present disclosure, referring to FIG. 3, may include:
(1) the robot detecting a persistent stuck state;
(2) initiating a local environment scan, identifying graspable objects and labeling semantic categories thereof;
(3) selecting a target with the highest contribution to stuck recovery (e.g., removing a sock that obstructs the path can free a passage width of 15 cm);
(4) the robotic arm performing a grasping and moving task and synchronously updating an obstacle map; and
(5) verifying a stuck recovery effect, and triggering a secondary strategy (e.g., a second attempt after pose adjustment by rotation) if the verification fails.

By means of the above technical solutions, the present disclosure achieves beneficial effects including:
1) active environmental modification capacity: the limitation that traditional sweepers can only passively avoid obstacles is broken through, and traversable conditions are actively created through physical intervention.
2) multi-system coordinated optimization: robotic arm control, object identification and the path planning algorithm are deeply integrated, achieving a technical effect of 1 + 1 > 2.
3) scenario adaptability improvement: cleaning tasks in clutter-intensive areas such as children’s rooms and entryways can be handled, reducing the need for manual pre-arrangement.
4) cost-effectiveness advantage: existing hardware resources of the robotic arm are reused, and functional extension is achieved through software upgrades.

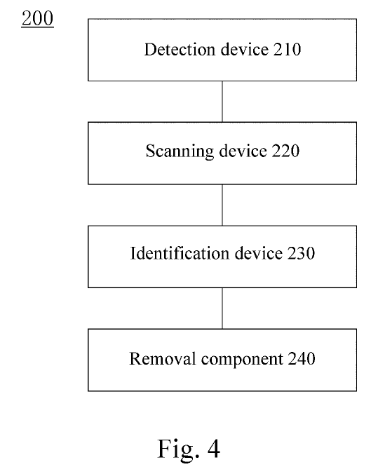

In another aspect, a stuck recovery system 200 for a self-moving cleaning robot is further provided in the present application. The self-moving cleaning robot is, for example, a floor-cleaning robot. As shown in the structural schematic diagram of FIG. 4, the stuck recovery system 200 may include:
a detection device 210 configured to detect whether the self-moving cleaning robot is in a stuck state;
a scanning device 220 configured to, in response to the self-moving cleaning robot being in the stuck state, scan a local stuck environment of the self-moving cleaning robot;
an identification device 230 configured to identify removable obstacles in the local stuck environment and a target obstacle among the removable obstacles; and
a removal component 240 disposed on the self-moving cleaning robot and configured to remove the target obstacle.

Specifically, the stuck recovery system 200 for a self-moving cleaning robot of the present disclosure may further include the following modules.

### (1) Multimodal perception module

A depth camera and a robotic arm end force sensor are provided to acquire environment three-dimensional information and obstacle attributes (size and material) in real time. Graspable objects (e.g., shoes, toys, wads of paper, and other predefined categories) are identified based on the visual AI model, and relative poses of the graspable objects with respect to the robotic arm are calculated.

### (2) Stuck-recovery decision-making module

A stuck-state determination unit determines, based on the cleaning logic, whether the “stuck state” is entered. A grasp feasibility analysis module determines whether a category of graspable item exists, and if so, an object that is lightweight and easy to grip and that can significantly increase the traversal space after being moved is preferentially selected.

### (3) Robotic arm control module

A pre-trained grasping strategy is invoked based an object type, and an obstacle-avoidance motion trajectory is planned. The object is moved to a temporary safety region and the robotic arm is retracted; or a current grasping state is temporarily maintained (when there is no safety region around).

### (4) Dynamic path replanning module

After an obstacle is removed, an environmental map is updated and a new stuck-recovery navigation path is generated. After the robot determines that it is no longer in the stuck environment, it chooses to move the item to a predetermined region first or to continue the cleaning logic, depending on a current state. If the robotic arm is currently in the grasping state, the item needs to be moved to the predetermined region before returning to the cleaning logic. If the robotic arm is currently in the retracted state, the cleaning logic may continue to be executed directly.

In an embodiment of the present application, the removal component is a robotic arm configured to grasp the target obstacle to remove the target obstacle. The robotic arm is further configured to: maintain the grasping state or move the target obstacle to a predefined safety region after the target obstacle is grasped.

In an embodiment of the present application, the identification device 220 is further configured to perform the following functions: determining, by means of a visual recognition model, the removable obstacles in the local stuck environment and a relative pose of each removable obstacle with respect to the removal component; and determining, by means of an obstacle contribution evaluation algorithm, the target obstacle among the removable obstacles. The removal component 230 is further configured to perform the following function: determining a removal path of the removal component based on the relative pose of each removable obstacle with respect to the removal component.

In an embodiment of the present application, the obstacle contribution evaluation algorithm includes: determining a removal contribution of each removable obstacle in a weighted manner based on a weight, a distance, a removal method, and an occupied space of each removable obstacle, and the identification device 220 is further configured to perform the following functions: determining, by means of the obstacle contribution evaluation algorithm, respective removal contributions of the removable obstacles; and determining a removable obstacle whose removal contribution is greater than the predefined threshold as the target obstacle.

In an embodiment of the present application, in the case of a plurality of removable obstacles, the identification device 220 is further configured to perform the following functions: determining, by means of the obstacle contribution evaluation algorithm, a ranking of the plurality of removable obstacles in descending order of contributions; and determining the first N removable obstacles in the contribution-based ranking as the target obstacle, where N is a predefined number.

In an embodiment of the present application, after removing the target obstacle, the stuck recovery system 200 for a self-moving cleaning robot of the present disclosure further includes: an update module configured to update an environmental map; a determination module configured to determine, based on the updated environmental map, whether the self-moving cleaning robot is in the stuck state; and a control module configured to, in response to determining that the self-moving cleaning robot is not in the stuck state, control the self-moving cleaning robot to perform a predefined task logic; or in response to determining that the self-moving cleaning robot is in the stuck state, iteratively execute the stuck recovery method for a self-moving cleaning robot, execute a secondary stuck recovery method, or trigger an alarm.

In an embodiment of the present application, the secondary stuck recovery method includes: controlling the self-moving cleaning robot to adjust stuck recovery poses; and controlling, at each stuck recovery pose, the self-moving cleaning robot to perform the stuck recovery method for a self-moving cleaning robot as described above.

In an embodiment of the present application, the determination module is further configured to determine whether the self-moving cleaning robot is in the stuck state by: planning a task path in the environmental map of the self-moving cleaning robot based on the predefined task logic of the self-moving cleaning robot; in response to successful planning of a task path satisfying the predefined task logic, determining that the self-moving cleaning robot is not in the stuck state; and in response to failure to plan a task path satisfying the predefined task logic, determining that the self-moving cleaning robot is in the stuck state.

In summary, the present disclosure aims to propose a stuck recovery system for a self-moving cleaning robot, achieving beneficial effects including:
1) active environmental modification capacity: the limitation that traditional sweepers can only passively avoid obstacles is broken through, and traversable conditions are actively created through physical intervention;
2) multi-system coordinated optimization: robotic arm control, object identification and the path planning algorithm are deeply integrated, achieving a technical effect of 1 + 1 > 2;
3) scenario adaptability improvement: cleaning tasks in clutter-intensive areas such as children's rooms and entryways can be handled, reducing the need for manual pre-arrangement;
4) cost-effectiveness advantage: existing hardware resources of the robotic arm are reused, and functional extension is achieved through software upgrades.

In a further aspect, a floor-cleaning robot is further provided in the present application. The floor-cleaning robot may include the stuck recovery system for a self-moving cleaning robot as described above.

With regard to the beneficial effects of the stuck recovery system for a self-moving cleaning robot and the floor-cleaning robot provided in the present disclosure, reference may be made to the above description of the stuck recovery method for a self-moving cleaning robot, which will not be described in detail here.

It should also be noted that the terms “comprise”, “include” or any other variations thereof are intended to cover non-exclusive inclusion, such that a process, method, item or device that includes a series of elements includes not only those elements, but also other elements not explicitly listed, or elements inherent to such a process, method, item or device. Without further limitations, an element defined by the phrase “comprising a …” does not exclude the presence of additional identical elements in a process, method, item, or device comprising the element.

The above are merely embodiments of the present application and are not intended to limit the present application. Various changes and variations may be made to the present application for those skilled in the art. Any modification, equivalent replacement, improvement and the like made within the spirit and principles of the present application should fall within the scope of protection of the present application.

What is claimed is:

1. A stuck recovery method for a self-moving cleaning robot, comprising:
detecting whether the self-moving cleaning robot is in a stuck state;
in response to the self-moving cleaning robot being in the stuck state, scanning a local stuck environment of the self-moving cleaning robot;
identifying removable obstacles in the local stuck environment and a target obstacle among the removable obstacles; and
removing the target obstacle by a removal component of the self-moving cleaning robot.

2. The stuck recovery method according to claim 1, wherein
the removal component is a robotic arm configured to grasp the target obstacle to remove the target obstacle, wherein removing the target obstacle by a removal component of the self-moving cleaning robot comprises:
determining whether a predefined safety region exists in the local stuck environment; and
in response to the existence of the predefined safety region, grasping the target obstacle by the robotic arm and moving the target obstacle to the predefined safety region.

3. The stuck recovery method according to claim 2, wherein
removing the target obstacle by a removal component of the self-moving cleaning further comprises:
in response to the non-existence of the predefined safety region, grasping the target obstacle by the robotic arm and maintaining a grasping state.

4. The stuck recovery method according to claim 1, wherein
identifying removable obstacles in the local stuck environment and a target obstacle among the removable obstacles comprises:
determining, by means of a visual recognition model, the removable obstacles in the local stuck environment and a relative pose of each removable obstacle with respect to the removal component; and
determining, by means of an obstacle contribution evaluation algorithm, the target obstacle among the removable obstacles,
wherein removing the target obstacle by a removal component of the self-moving cleaning comprises: determining a removal path of the removal component based on the relative pose of each removable obstacle with respect to the removal component.

5. The stuck recovery method according to claim 4, wherein
the obstacle contribution evaluation algorithm comprises: calculating a spatial release volume of each removable obstacle; and
the number of target obstacles is set to one, and determining, by means of an obstacle contribution evaluation algorithm, the target obstacle among the removable obstacles further comprises:
determining, by means of the obstacle contribution evaluation algorithm, a ranking of a plurality of removable obstacles in descending order of spatial release volumes; and
determining a removable obstacle with the greatest spatial release volume as the target obstacle.

6. The stuck recovery method according to claim 4, wherein
the obstacle contribution evaluation algorithm comprises: determining a removal contribution of each removable obstacle in a weighted manner based on a weight, a distance, a removal method, and an occupied space of each removable obstacle,
wherein the number of target obstacles is set to one or more, and determining, by means of an obstacle contribution evaluation algorithm, the target obstacle among the removable obstacles comprises:
determining, by means of the obstacle contribution evaluation algorithm, respective removal contributions of the removable obstacles and a maximum removal contribution among the removal contributions; and
in response to the maximum removal contribution being greater than or equal to a predefined threshold, determining each of one or more removable obstacles whose removal contributions are greater than the predefined threshold as the target obstacle.

7. The stuck recovery method according to claim 5, wherein
there are a plurality of removable obstacles, and determining, by means of an obstacle contribution evaluation algorithm, the target obstacle among the removable obstacles further comprises:
in response to the maximum removal contribution being less than the predefined threshold, determining a ranking of the plurality of removable obstacles in descending order of contributions;
determining, based on the contribution-based ranking, the first N removable obstacles whose sum of removal contributions is greater than the predefined threshold, where N ≥ 2; and
determining the first N removable obstacles as the target obstacle.

8. The stuck recovery method according to claim 6, wherein
there are a plurality of removable obstacles, and determining, by means of an obstacle contribution evaluation algorithm, the target obstacle among the removable obstacles further comprises:
in response to the maximum removal contribution being less than the predefined threshold, determining a ranking of the plurality of removable obstacles in descending order of contributions;
determining, based on the contribution-based ranking, the first N removable obstacles whose sum of removal contributions is greater than the predefined threshold, where N ≥ 2; and
determining the first N removable obstacles as the target obstacle.

9. The stuck recovery method according to claim 1, wherein
after removing the target obstacle by a removal component of the self-moving cleaning, the stuck recovery method further comprises:
updating an environmental map; and
determining, based on the updated environmental map, whether the self-moving cleaning robot is in the stuck state,
wherein in response to determining that the self-moving cleaning robot is not in the stuck state, the self-moving cleaning robot is controlled to perform a predefined task logic; or
in response to determining that the self-moving cleaning robot is in the stuck state, the stuck recovery method for a self-moving cleaning robot is iteratively executed, a secondary stuck recovery method is executed, or an alarm is triggered.

10. The stuck recovery method according to claim 9, wherein
the secondary stuck recovery method comprises:
controlling the self-moving cleaning robot to adjust stuck recovery poses; and
controlling, at each stuck recovery pose, the self-moving cleaning robot to perform the stuck recovery method for a self-moving cleaning robot.

11. The stuck recovery method according to claim 1, wherein
the stuck recovery method further comprises determining whether the self-moving cleaning robot is in the stuck state by:
planning a task path in the environmental map of the self-moving cleaning robot based on the predefined task logic of the self-moving cleaning robot;
in response to successful planning of a task path satisfying the predefined task logic, determining that the self-moving cleaning robot is not in the stuck state; and
in response to failure to plan a task path satisfying the predefined task logic, determining that the self-moving cleaning robot is in the stuck state.

12. The stuck recovery method according to claim 8, wherein
the stuck recovery method further comprises determining whether the self-moving cleaning robot is in the stuck state by:
planning a task path in the environmental map of the self-moving cleaning robot based on the predefined task logic of the self-moving cleaning robot;
in response to successful planning of a task path satisfying the predefined task logic, determining that the self-moving cleaning robot is not in the stuck state; and
in response to failure to plan a task path satisfying the predefined task logic, determining that the self-moving cleaning robot is in the stuck state.

13. A stuck recovery system for a self-moving cleaning robot, comprising:
a detection device configured to detect whether the self-moving cleaning robot is in a stuck state;
a scanning device configured to, in response to the self-moving cleaning robot being in the stuck state, scan a local stuck environment of the self-moving cleaning robot;
an identification device configured to identify removable obstacles in the local stuck environment and a target obstacle among the removable obstacles; and
a removal component disposed on the self-moving cleaning robot and configured to remove the target obstacle.

14. The stuck recovery system according to claim 13, wherein
the removal component is a robotic arm configured to grasp the target obstacle to remove the target obstacle, wherein the removal component is specifically configured for:
determining whether a predefined safety region exists in the local stuck environment; and
in response to the existence of the predefined safety region, grasping the target obstacle by the robotic arm and moving the target obstacle to the predefined safety region.

15. The stuck recovery system according to claim 14, wherein
the removal component is further configured for:
in response to the non-existence of the predefined safety region, grasping the target obstacle by the robotic arm and maintaining a grasping state.

16. The stuck recovery system according to claim 13, wherein
the identification device is specifically configured for:
determining, by means of a visual recognition model, the removable obstacles in the local stuck environment and a relative pose of each removable obstacle with respect to the removal component; and
determining, by means of an obstacle contribution evaluation algorithm, the target obstacle among the removable obstacles,
wherein the removal component is specifically configured for: determining a removal path of the removal component based on the relative pose of each removable obstacle with respect to the removal component.

17. The stuck recovery system according to claim 16, wherein
the obstacle contribution evaluation algorithm comprises: calculating a spatial release volume of each removable obstacle; and
the number of target obstacles is set to one, and the identification device is further configured for:
determining, by means of the obstacle contribution evaluation algorithm, a ranking of a plurality of removable obstacles in descending order of spatial release volumes; and
determining a removable obstacle with the greatest spatial release volume as the target obstacle.

18. The stuck recovery system according to claim 16, wherein
the obstacle contribution evaluation algorithm comprises: determining a removal contribution of each removable obstacle in a weighted manner based on a weight, a distance, a removal method, and an occupied space of each removable obstacle,
wherein the number of target obstacles is set to one or more, and the identification device is further configured for:
determining, by means of the obstacle contribution evaluation algorithm, respective removal contributions of the removable obstacles and a maximum removal contribution among the removal contributions; and
in response to the maximum removal contribution being greater than or equal to a predefined threshold, determining each of one or more removable obstacles whose removal contributions are greater than the predefined threshold as the target obstacle.

19. A floor-cleaning robot, comprising the stuck recovery system according to claim 13.
